(19) United States
(12) Patent Application Publication
(10) Pub. No.: US 2005/0059754 A1
(43) Pub. Date: Mar. 17, 2005

(54) Electrically conductive, flame retardant fillers, method of manufacture, and use thereof

(76) Inventors: Michael S. Lunt, Abington, CT (US); Michael D. Bessette, Sun Lakes, AZ (US); Sankar K. Paul, Branford, CT (US)

Correspondence Address: CANTOR COLBURN, LLP, 55 GRIFFIN ROAD SOUTH, BLOOMFIELD, CT, 06002, US

(21) Appl. No.: 10/903,865

(22) Filed: Jul. 30, 2004

Related U.S. Application Data
(60) Provisional application No. 60/491,509, filed on Jul. 31, 2003.

(51) Int. Cl. C08K 9/12; C08K 9/10

(52) U.S. Cl. 523/210; 252/609

(57) ABSTRACT

A conductive, flame retardant composition is formed from a particulate flame retardant coated with a conductive metal. The composition can provide both conductivity and flame retardance to polymeric compositions such as adhesives, foams, and elastomers.

### CROSS-REFERENCE TO RELATED APPLICATION

This application claims the benefit of the filing of U.S. Provisional Application No. 60/491,509, filed Jul. 31, 2003, which is incorporated herein by reference in its entirety.

### BACKGROUND

This invention relates to electrically conductive, flame retardant fillers suitable for use in polymeric and adhesive compositions, and methods of manufacture thereof.

Electrically conductive elastomers and foams are of utility in a wide variety of applications, including as electrical contacting devices, in sensors, and in applications requiring EMI/RFI shielding and/or electrostatic dissipation. Current materials capable of EMI/RFI shielding include, for example, beryllium-copper finger stock, metal foil or metallized fabric wrapped around non-conductive foam gaskets, non-conductive gaskets coated with conductive materials, highly filled-expanded polytetrafluoroethylene (hereinafter PTFE), and metal-based fillers loaded into silicone resins. Electrically conductive addition cure silicone compositions have been described, for example, in U.S. Pat. No. 5,932,145 to Mitani et al., U.S. Pat. No. 6,017,587 to Kleyer et al., European Patent No. 0 839 870, and European Patent No. 0 971 367. Other electrically conductive elastomers and foams are also known, for example certain polyurethanes and polyolefins.

It is often desirable in the above applications to use an electrically conductive adhesive, particularly a pressure-sensitive adhesive (PSA), to adhere the elastomer or foam to a substrate. Electrical conductivity is most often achieved in PSAs by adding electrically conductive fillers such as particulate polyaniline (see U.S. Pat. No. 5,645,764); particulate metals such as silver or copper (see U.S. Pat. No. 3,475,213 and U.S. Pat. No. 4,258,100); and carbonyl nickel powder (U.S. Pat. No. 3,762,946). The carbonyl nickel powder of this last patent is produced by thermal decomposition of nickel carbonyl, yielding small particles of “complex shape” and low apparent density.

It would be a further advantage to provide such polymers and PSA compositions with flame retardance, in particular flame retardance that meets certain Underwriter's Laboratories (UL) standards for flame retardance. In this regard, if each of the individual components within a device is UL approved, then the device itself does not require separate approval. Ensuring UL approval for each component therefore reduces the cost of compliance for the manufacturer. For EMI shielding gaskets, the gaskets will preferably achieve a rating of V-0 under UL Standard 94, but such rating must be achieved without significantly compromising the conductivity, and hence shielding effectiveness of the gasket. It is further important that the particular physical properties of the elastomer, foam, and/or PSA that are desired for a particular application not be significantly adversely affected.

There accordingly remains a need in the art for compositions and methods whereby elastomers, foams, and/or PSAs can be provided with both electrical conductivity and flame retardance, particularly without significant adverse effect on one or more physical properties desired for a particular application.

### BRIEF SUMMARY

The above-described drawbacks and disadvantages are alleviated by an electrically conductive, flame retardant filler comprising flame retardant particles coated with a conductive metal. In an unexpected feature, it has been found that even when flame retardant particles are coated with a conductive metal, the particles nonetheless provide effective flame retardance.

Accordingly, further disclosed is an electrically conductive, flame retardant composition comprising a polymer and a filler composition, the filler composition comprising flame retardant particles coated with a conductive metal. Articles formed from such compositions are also within the scope of the invention. The polymer may be an elastomer or a foam. In another unexpected feature, it has been found that the inventive particles can provide both conductivity and flame retardance without significantly adversely affecting the desired properties of the elastomer or foam. The compositions and/or articles have a volume resistivity of about 10⁻³ ohm-cm to about 10⁸ ohm-cm, and meet the UL-94 standard of V-0 or better. The above discussed and other features and advantages of the present invention will be appreciated and understood by those skilled in the art from the following detailed description.

### BRIEF DESCRIPTION OF THE DRAWING

The FIGURE is a schematic diagram of an exemplary pressure sensitive adhesive tape.

### DETAILED DESCRIPTION

The inventors hereof have unexpectedly found that flame retardant particles can be treated to provide electrical conductivity as well as flame retardance to a composition. In a further unexpected feature, such particles can be used without significantly affecting the physical properties of the compositions. Thus, in a preferred embodiment, polymeric foams and elastomers may be produced that are electrically conductive, and that also retain their compressibility, flexibility, compression set resistance, cell uniformity (in the case of foams), and the like. These materials are particularly suitable for use in the formation of articles that can provide electromagnetic shielding and/or electrostatic dissipation. Uses include applications involving complicated geometries and forms, such as in computers, personal digital assistants, cell phones, medical diagnostics, and other wireless digital devices, electronic goods such as cassette and digital versatile disk players, as well as in automobiles, ships and aircraft, and the like, where high strength to weight ratios are desirable.

Suitable flame retardant materials for use in forming the particles include, for example, a metal hydroxide containing aluminum, magnesium, zinc, boron, calcium, nickel, cobalt, tin, molybdenum, copper, iron, titanium, or a combination thereof, for example aluminum trihydroxide, magnesium hydroxide, calcium hydroxide, iron hydroxide, and the like; a metal oxide such as antimony oxide, antimony trioxide, antimony pentoxide, iron oxide, titanium oxide, manganese oxide, magnesium oxide, zirconium oxide, zinc oxide, molybdenum oxide, cobalt oxide, bismuth oxide, chromium oxide, tin oxide, nickel oxide, copper oxide, tungsten oxide, and the like; metal borates such as zinc borate, zinc metaborate, barium metaborate, and the like; metal carbonates such as zinc carbonate, magnesium carbonate, calcium carbonate, barium carbonate, and the like; melamine cyanurate, melamine phosphate, and the like; carbon black, expandable graphite flakes (for example those available from GrafTech International, Ltd. under the tradename GRAFGUARD), and the like; nanoclays; and brominated compounds.

Suitable magnesium hydroxides include not only Mg(OH)₂, but also other natural or synthetic products that contain magnesium ions and, as anions, predominantly hydroxide ions, such as brucite, natural or synthetic magnesium hydroxycarbonates such as huntite or hydromagnesite, or synthetic magnesium hydroxides as sold for example by Alusuisse Martinswerk GmbH under the trade mark MAGNIFIN®. Combinations of magnesium hydroxides may also be used.

Nanoclays have the additional advantage of high aspect ratio but may require special treatment to separate the nanolayers to achieve the desired high surface area (exfoliation). An exemplary nanoclay is natural montmorillonite, produced, for example, by Southern Clay using various organic modifiers, under the trade names CLOISITE 10A, 15A, 20A, 25A, 30B, and 93A. In order to get exfoliation of layers, CLOISITE 30B is preferred. Exfoliation of CLOISITE 20A was performed in PHT4-DIOL at elevated temperature (100° C.).

Solid brominated compounds may also be used, for example hexabromocyclododecane, brominated indan, ethylenebis(tetrabromophthalimide), bis(tribromophenoxy)ethane, tris(tribromophenyl)cyanurate, decabromodiphenyl oxide, tetradecabromodiphenoxybenzene, ethane-1,2-bis(pentabromophenyl), brominated polystyrene, and the like. Mixtures including any one or more of the foregoing flame retardants may also be used.

The flame retardants are used in particulate form. A variety of irregular or regular shapes may be used, e.g., spherical, flake, plate- or rod-like. The average largest dimension of the particles is about 0.250 to about 250 micrometers. Preferably within this range, the average largest dimension is greater than or equal to about 1 micrometer. Also within this range, the average particle size of the conductive filler is preferably less than or equal to about 200 micrometers. This average size can be achieved with single filler, or a mixture of fillers having various average particle sizes. Smaller particles will typically be used with adhesives, for example those having an average largest dimension of about 0.1 to about 100 micrometers.

Suitable conductive materials are capable of being deposited on the flame retardant particles capable of providing sufficient conductivity upon coating. Suitable materials include, for example conductive metals such as gold, silver, nickel, copper, aluminum, chromium, cobalt, iron, and the like, as well as alloys containing at least one of the foregoing metals.

Coating may be by means known in the art, for example vapor deposition, electroless plating, and the like. In one embodiment, an electroless plating process may be used to deposit silver onto aluminum trihydrate. In another embodiment, vapor deposition of nickel carbonyl may be used to provide a nickel coating. A sufficient amount of conductive material is coated onto the flame retardant particles such that the particles, when used to form composites, impart the desired level of conductivity to the composite, preferably without significantly adversely affecting the desired properties of the polymer or adhesive. It has been found that it is not necessary for all of the particles to be coated, or for the coating to completely cover each particle. Particles that are at least substantially coated may therefore be used. For example, in a given batch of particles, at least about 60% of the total surface area of the particles are coated, specifically at least about 70%, and more specifically at least about 80%, and even more specifically at least about 90% of the total surface area of the particles may be coated.

The thickness of the coating does not appear to be critical, and may be, for example, about 0.5 to about 5 mils (about 13 to about 130 micrometers), specifically about 1 to about 3 mils (about 26 to about 78 micrometers) thick.

The coated flame retardant particles may be used in adhesives such as PSAs, foams, and elastomers. The term “pressure sensitive adhesive” or “PSA” is used herein in its conventional sense to mean that the composition is formulated to have a glass transition temperature, surface energy, and/or other properties such that it exhibits some degree of tack at normal room temperature. Thus, the constituent polymers and/or copolymers of the composition generally will have a glass transition temperature of less than about 0° C. such that the mass of the composition is tacky at ambient temperatures and is thereby bondable under an applied pressure to a surface or other substrate. In general, the formulation of the adhesive composition specifically may be selected to exhibit an affinity, as may be measured by lap shear, die shear, static or dynamic shear, peel, or other adhesion, to the material forming the substrate or substrates involved in the particular application, but which affinity is less than to the material forming a backing layer as described below. Such adhesion affinities may depend particularly on the surface energy of the materials involved, and may be developed from surface tension, valence, polar, electrostatic, van der Waals, or other attractive forces, mechanical interlocking action, or a combination thereof.

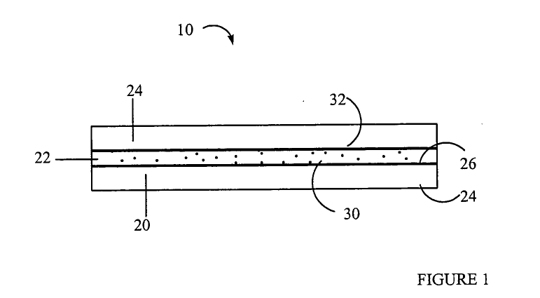

In use, pressure sensitive adhesives are generally provided in the form of a tape. An exemplary embodiment of a pressure sensitive adhesive tape is shown generally at FIG. 1, and comprises tape 10, which may have an overall thickness of between about 1.0-10.5 mils (0.025-0.267 mm), may be provided in the form of, or as formed from, a sheet, roll, tape, die-cut part, or the like. Tape 10, which may be of an indefinite length and/or width, includes a backing strip, sheet, or other generally flat layer 20, an adhesive layer 22 on at least one side or portion of backing layer 20, and, optionally, a release liner 24 for covering adhesive layer 22 during shipping and handling. Although adhesive layer 22 is shown as being coated on substantially the entirety of backing layer 20, adhesive layer 22 may alternatively be applied in a pattern or otherwise to cover only a portion of backing layer 20. For most applications, backing layer 20 can have a thickness of about 0.5-8 mils (0.013-0.203 mm), with adhesive layer 22 having a thickness of about 0.5-2.5 mils (0.013-0.064 mm).

Backing layer 20 has a first side or surface 24 and an opposing second side or surface 26. Adhesive layer 22 may be coated or laminated on, or otherwise bonded to or in intimate contact with second side 26 of the backing layer 20 to provide the laminar structure of tape 10. Depending on the intended application, a second adhesive layer 22 may be coated on backing layer first side 24 (not shown). Adhesive layer 22 has an inner face 30 adhesively or otherwise bonded to second side 26, and an opposite outer face 32 that is adhesively bondable under an applied pressure to a surface of a substrate.

Backing layer 20 may be a formed of a synthetic, natural, or glass fiber fabric, paper, or foamed or unfoamed plastic, resin, elastomer, or other polymeric or other material conventionally used in tape construction. In one embodiment, backing layer 20 is removable after bonding of adhesive layer 22 to the surface of a substrate. A second substrate may then be applied to the exposed face 30. In another embodiment, for example EMI shielding applications, backing layer 20 can be formed of an electrically-conductive material such as a conductive polymer, a conductive metal foil, or a cloth plated with a conductive metal such as copper, aluminum, nickel, silver, or alloys or mixtures comprising at least one of the foregoing conductive metals. Where similar materials are used for the substrate and backing layer 20, the backing layer second side 26 may be coated, prior to the application of the adhesive layer, with a higher surface energy “tie” layer so as to increase the affinity of the adhesive layer 22 thereto relative to the substrate surface. Such tie layer may be formed as a chemical bond coat, such as a thermoplastic dissolved in a solvent, which is applied to the side 26 and dried or otherwise cured thereon to form an intermediate tie layer between the side and the adhesive layer 22. Alternatively, other known surface treatments may employed such as cleaning or roughening the side 26 with one or more of compressed gas, chemical or solvent etching/cleaning, grit-blasting, such as with aluminum oxide or other abrasive, or plasma, such as may be generated from the ionization of oxygen, argon, or another gas or mixture of gases.

Exemplary release liners 24 include face stocks or other films of polyolefins, plasticized polyvinyl chloride, polyesters, cellulosics, metal foils, composites, and waxed, siliconized, or other coated paper or plastic having a relatively low surface energy to be removable without appreciable lifting of the adhesive layer 22 from the backing layer 20.

Manufacture of the pressure sensitive adhesives is by processes recognized in the art. In general, the compositions for formation of the adhesive, additives, e.g., catalyst, crosslinking agent, additional fillers, and the like (which are described in further detail below), and the electrically conductive and flame retardant particles are mixed, frothed and/or blown if desired, shaped (e.g., cast), then cured, if applicable. Stepwise addition of the various components may also be used, e.g., the electrically conductive and flame retardant particles may be provided in the form of a masterbatch, and added after the other components are mixed.

Accordingly, in the production of commercial quantities of tape 10, the formulation for the adhesive layer 22 may be compounded in a conventional mixing apparatus as an admixture of a PSA composition, the particulate, flame retardant conductive filler, any additional fillers and/or additives, and a solvent or diluent. The formulation may be coated or otherwise applied to side 26 of the backing layer 20 in a conventional manner such as, for example, by a direct process such as spraying, knife coating, roller coating, casting, drum coating, dipping, dispensing, extrusion, screen printing, or like, or an indirect transfer process. After coating, the resultant film may be dried to remove the solvent or otherwise cured or cooled to develop an adherent film on backing layer 20. Curing, where used, is inclusive of polymerization, crosslinking, vulcanization, or otherwise chemical or physical changes that result in formation of a generally solid film from the applied composition. As a result of the inherent tack of the PSA film, an adhesive and/or mechanical bond may be developed between the layers 20 and 22 to form the integral, laminate structure of tape 10. Alternatively, the adhesive layer 22 may be separately formed and laminated under conditions of elevated temperature and/or pressure to the backing layer 20 in a separate operation.

A variety of pressure sensitive adhesive formulations may be suitable for use, and include film-forming materials such as a natural or synthetic rubber or elastomer, or other resin, plastic, or polymer exhibiting rubber-like properties of compliancy, resiliency or compression deflection, low compression set, flexibility, and an ability to recover after deformation. Examples of such materials include styrene-butadienes, styrene-isoprenes, polybutadienes, polyisobutylenes, polyurethanes, silicones, fluorosilicones and other fluoropolymers, chlorosulfonates, butyls, neoprenes, nitriles, polyisoprenes, plasticized nylons, polyesters, polyvinyl ethers, polyvinyl acetates, polyisobutylenes, ethylene vinyl acetates, polyolefins, and polyvinyl chlorides, copolymer rubbers such as ethylene-propylene (EPR), ethylene-propylene-diene monomer (EPDM), styrene-isoprene-styrene (SIS), styrene-butadiene-styrene (SBS), nitrile-butadienes (NBR) and styrene-butadienes (SBR), blends such as ethylene or propylene-EPDM, EPR, or NBR, and mixtures, blends, and copolymers thereof.

These materials may be compounded with a tackifier, which may be a resin such as glyceryl esters of hydrogenated resins, thermoplastic terpene resins, petroleum hydrocarbon resins, coumarone-indene resins, synthetic phenol resins, low molecular weight polybutenes, or a tackifying silicone. Generally, the tackifying resin may be compounded into the resin material at between about 40-150 parts per hundred parts of the resin.

Additional fillers and additives may be included in the PSA composition depending upon the requirements of the particular application, for example conventional wetting agents or surfactants, pigments, dyes, and other colorants, opacifying agents, anti-foaming agents, anti-static agents, coupling agents such as titanates, chain extending oils, lubricants, stabilizers, emulsifiers, antioxidants, thickeners, and/or flame retardants such as aluminum trihydrate, antimony trioxide, metal oxides and salts, intercalated graphite particles, phosphate esters, brominated diphenyl compounds such as decabromodiphenyl oxide, borates, phosphates, halogenated compounds, glass, silica, silicates, and mica. Typically, these fillers and additives are blended or otherwise admixed with the formulation, and may comprise between about 0.05-80% or more by total volume thereof.

Aqueous pressure sensitive adhesive compositions are useful with the above-described coated flame retardants, for example those comprising a mechanically stable aqueous emulsion of polyethylene particles having an average molecular weight ranging from about 7,000 to 40,000 as described in U.S. Pat. No. 3,734,686; ethylene polymer latexes containing ethylene polymer particles of submicron size prepared by dispersing in water an ethylene polymer and a water-soluble block copolymer of ethylene oxide and propylene oxide as described in U.S. Pat. No. 3,418,26; latexes prepared from copolymers of ethylene and C₃-C₂₀ ce-olefins as in U.S. Pat. No. 5,574,091; or compositions comprising homogenous ethylene/alpha-olefin interpolymers and substantially random interpolymers as disclosed in U.S. Pat. No. 6,521,696.

Another useful type of pressure sensitive adhesive composition is based on (meth)acrylates (i.e., acrylates and methacrylates). Such compositions include, for example, copolymers derived from compositions containing, based on the total weight of the monomer components, about 50 to about 99 weight percent of C₄-C₁₈ alkyl esters of (meth)acrylic acids, about 1 to about 50 weight percent of polar ethylenically unsaturated comonomers such as itaconic acid, certain substituted acrylamides such a N,N-dimethyl acrylamide, N-vinyl-2-pyrrolidone, or n-vinyl caprolactam, acrylonitrile, acrylic acid, glycidyl acrylate, and the like, and optionally, up to about 25 weight percent of a non-polar ethylenically unsaturated comonomer such as cyclohexyl acrylate, n-octyl acrylamide, t-butyl acrylate, methyl methacrylate, and the like, and/or a tackifier.

Other additives such as crosslinking agents may also be present, for example include di- and triacrylates, for instance 1,6-hexanediol diacrylate; and photoinitiators such as 1-hydroxycyclohexyl phenyl ketone or 2,2-dimethoxy-2-phenylacetophenone, which are commercially available from Ciba-Geigy under the trade names respectively of IRGACURE 184 and IRGACURE 651, or other photoinitiators for ethylenically-unsaturated monomers which are well known in the art. Cross-linking agents and photoinitiators, are each generally used in amounts of about 0.005 to about 0.5 weight percent, based on total weight of monomer composition. Suitable (meth)acrylate pressure sensitive adhesives are disclosed, for example, in U.S. Pat. No. 4,223,067; U.S. Pat. No. 4,181,752 U.S. Pat. No. 5,183,833; U.S. Pat. No. 5,645,764, and U.S. Pat. No. Re. 24,906. Suitable compositions are also commercially available.

The (meth)acrylate containing monomer mixture may be polymerized by various techniques, preferably photoinitiated bulk polymerization as described, for example, in U.S. Pat. No. 5,620,795, wherein the polymerizable comonomers and a photoinitiator are mixed together in the absence of solvent and partially polymerized to a viscosity of about 500 to about 50,000 cps to achieve a coatable syrup. Alternatively, the monomers may be mixed with a thixotropic agent such as fumed hydrophilic silica to achieve a coatable thickness. A crosslinking agent, the coated flame retardant, and any other components (including any tackifiers) are then added to the prepolymerized syrup. Alternatively, these components (including any tackifiers but with the exception of the crosslinking agent) can be added directly to the monomer mixture prior to pre-polymerization.

The resulting composition is coated onto a substrate (which may be transparent to ultraviolet radiation) and polymerized in an inert (i. e., oxygen free) atmosphere, e.g., a nitrogen atmosphere by exposure to ultraviolet radiation. Examples of suitable substrates include release liners (e.g., silicone release liners) and tape backings (which may be primed or unprimed paper or plastic). A sufficiently inert atmosphere can also be achieved by covering a layer of the polymerizable coating with a plastic film which is substantially transparent to ultraviolet radiation, and irradiating through that film in air as described in the aforementioned Martens et al. patent using ultraviolet lamps. The ultraviolet light source preferably has 90% of the emissions between 280 and 400 nm (more preferably between 300 and 400 nm), with a maximum at 351 nm. Where multi-layer tape constructions are desirable, a variety of conventional techniques may be used. For example, the coatings may be applied concurrently (e.g., through a die coater), after which the entire multi-layer structure is cured at the same time. The coatings may also be applied sequentially whereby each individual layer is partially or completely cured prior to application of the next layer.

Typically, tape 10 will be bondable to the substrate surface under firm hand pressure, and will exhibit thereon a 180° peel adhesion, such as may be determined in accordance with PSTC-1 (Pressure Sensitive Tape Council Test Methods for Pressure Sensitive Adhesive Tapes, Pressure Sensitive Tape Council, Northbrook, Ill. 60062), of between about 0.5-5.0 lb/in (0.26-0.87 N/m) initial. Preferably, such adhesion will be observed to increase or “build” on aging by less than about 50%.

The electrically conducting, flame retardant filler may also be used in polymeric foam or elastomer compositions. As used herein, “foams” refers to materials having a cellular structure and densities lower than about 65 pounds per cubic foot (pcf), preferably less than or equal to about 55 pcf, more preferably less than or equal to about 45 pcf, most preferably less than or equal to about 40 pcf. It is also generally desirable to have a void content of about 20 to about 99%, preferably greater than or equal to about 30%, and more preferably greater than or equal to about 50%, each based upon the total volume of the electrically conductive polymeric foam. The polymer for use in the polymeric electrically conductive polymeric foams may be selected from a wide variety of thermoplastic resins, blends of thermoplastic resins, or thermosetting resins. Examples of thermoplastic resins that may be used in the polymeric foams include polyacetals, polyacrylics, styrene acrylonitrile, acrylonitrile-butadiene-styrene, polyurethanes, polycarbonates, polystyrenes, polyethylenes, polypropylenes, polyethylene terephthalates, polybutylene terephthalates, polyamides such as, but not limited to Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, or the like, or combinations comprising at least one of the foregoing thermoplastic resins.

Examples of blends of thermoplastic resins that may be used in the polymeric foams include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR) or the like, or combinations comprising at least one of the foregoing blends.

Examples of polymeric thermosetting resins that may be used in the polymeric foams include polyurethanes, natural rubber, synthetic rubber, ethylene propylene diene monomer (EPDM), epoxys, phenolics, polyesters, polyamides, silicones, or the like, or combinations comprising at least one of the foregoing thermosetting resins. Blends of thermosetting resins as well as blends of thermoplastic resins with thermosetting resins may be utilized in the polymeric foams.

The polymers for use in electrically conductive elastomers include those having an intrinsic Shore A Hardness of less than or equal to about 80, preferably less than or equal to about 60, and more preferably less than or equal to about 40, and include thermosetting resins such as styrene butadiene rubber (SBR), EPDM, polyurethanes, and silicones as well as thermoplastic resins such as EPR, and elastomers derived from polyacrylics, polyurethanes, polyolefins, polyvinyl chlorides, or combinations comprising at least one of the foregoing elastomeric materials.

Manufacture of the various polymeric foams and elastomers is generally by processes recognized in the art. In general, the polymeric resins (in the case of thermoplastic resins and resin blends) or composition for the formation of the polymer (in the case of thermosetting resins), additives, e.g., catalyst, crosslinking agent, additional fillers, and the like, and the filler(s) are mixed, frothed and/or blown if desired, shaped (e.g., cast or molded), then cured, if applicable. Stepwise addition of the various components may also be used, e.g., the electrically conductive, flame retardant fillers (with or without other fillers or additives) may be provided in the form of a masterbatch, and added downstream, for example in an extruder. The foams may be produced in the form of sheets, tubes, or chemically or physically blown bun stock materials. The elastomers are generally produced in the form of sheets, tubes, conduits, slabs, meshes, or the like, or combinations comprising at least one of the foregoing form.

In each of the above-described applications, the amount of electrically conductive and flame retardant particles in the will vary depending on the nature of the adhesive, the nature of the particles, the intended use, the desired electrical conductivity, the desired flame retardance, and similar factors, and can be readily determined by one of ordinary skill in the art. In general, the particles will comprise about 10 to about 90% of the compositions by weight, specifically about 30 to about 80% by weight of the total composition.

Other electrically conductive fillers may additionally be used to attain a desired conductivity, such as carbon black, carbon fibers such as PAN fibers, metal-coated fibers or spheres such as metal-coated glass fibers, metal-coated carbon fibers, metal-coated organic fibers, metal coated ceramic spheres, metal coated glass beads and the like, inherently conductive polymers such as polyaniline, polypyrrole, polythiophene in particulate or fibril form, conductive metal oxides such as tin oxide or indium tin oxide, and combinations comprising at least one of the foregoing conductive fillers may also be used.

Of course, it is also possible to use known flame retardant materials in the compositions to provide additional flame retardancy, for example those described above in connection with the flame retardant particles.

The amount of these fillers is preferably selected so as to not adversely affect the final properties of the polymeric foams and elastomers. Typically, additional amounts of conductive or flame retardant fillers may be about 1 to about 50 wt % based on the total weight of the composition. Within this range it is possible to have an amount of greater than or equal to about 5.0, preferably greater than or equal to about 10 wt % of the total weight of the composition. Also desirable is an amount of less than or equal to about 40, more preferably less than or equal to about 30 wt %, of the total weight of the composition.

In addition to any additional electrically conducting filler(s) and/or flame retardant filler(s), other fillers, e.g., reinforcing fillers such as silica may also be present. In a preferred embodiment, a thermally conductive or thermally non-conductive filler is used to provide thermal management as well as electrical conductivity. Known thermally conductive fillers include metal oxides, nitrides, carbonates, or carbides (hereinafter sometimes referred to as “ceramic additives”). Such additives may be in the form of powder, flake, or fibers. Exemplary materials include oxides, carbides, carbonates, and nitrides of tin, zinc, copper, molybdenum, calcium, titanium, zirconium, boron, silicon, yttrium, aluminum or magnesium, or, mica, glass ceramic materials or fused silica. When present, the thermally conductive materials are added in quantities effective to achieve the desired thermal conductivity, generally an amount of about 10 to about 500 weight parts. Within this range, it is desirable to add the thermally conductive materials in an amount of greater than or equal to about 30, preferably greater than or equal to about 75 weight parts based on the total weight of the composition. Also desirable within this range is an amount of less than or equal to about 150 weight parts, preferably less than or equal to about 100 weight parts based on the total weight of the composition.

Use of the electrically conductive, flame retardant fillers enables the production of electrically conductive adhesives, in particular pressure sensitive adhesives, having a volume resistivity of about 10⁻³ ohm-cm to about 10⁸ ohm-cm. Within this range, the volume resistivity can be less than or equal to about 10⁶, less than or equal to about 10⁴, or less than or equal to about 10³, and is preferably less than or equal to about 10², more preferably less than or equal to about 10, and most preferably less than or equal to about 1 ohm-cm.

Use of the electrically conductive, flame retardant fillers enables the production of electrically conductive polymeric foams having a volume resistivity of about 10⁻³ ohm-cm to about 10⁸ ohm-cm. Within this range, the volume resistivity can be less than or equal to about 10⁶, less than or equal to about 10⁴, or less than or equal to about 10³, and is preferably less than or equal to about 10², more preferably less than or equal to about 10, and most preferably less than or equal to about 1 ohm-cm.

Use of the electrically conductive, flame retardant fillers also allows the production of electrically conductive elastomers having Shore A durometer of less than or equal to about 80, preferably less than or equal to about 70, more preferably less than or equal to about 50 and most preferably less than or equal to about 40, as well as a volume resistivity of about 10⁻³ ohm-cm to about 10³ ohm-cm. Within this range it is desirable to have a volume resistivity less than or equal to about 10² ohm-cm. Also desirable within this range is a volume resistivity less than or equal to about 10, and more preferably less than or equal to about 1 ohm-cm.

In a preferred embodiment, the polymeric foams and elastomers may provide electromagnetic shielding in an amount of greater than or equal to about 50 decibels (dB), preferably greater than or equal to about 70 dB, even more preferably greater than or equal to about 80 dB. Electromagnetic shielding is commonly measured in accordance with MWL-G-83528B.

In a particularly preferred embodiment, the volume resistivity of the polymeric foam and/or elastomer is less than or equal to about 1, and the electromagnetic shielding is greater than or equal to about 80 dB.

Polyurethane foams and elastomers, polyolefin foams and elastomers, and silicone foams and elastomers are particularly suited for use in the present invention.

In general, polyurethane foams and elastomers are formed from compositions comprising an organic polyisocyanate component, an active hydrogen-containing component reactive with the polyisocyanate component, a surfactant, and a catalyst. The process of forming the foam may use chemical or physical blowing agents, or the foam may be mechanically frothed. For example, one process of forming the foam comprises substantially and uniformly dispersing inert gas throughout a mixture of the above-described composition by mechanical beating of the mixture to form a heat curable froth that is substantially structurally and chemically stable, but workable at ambient conditions; and curing the froth to form a cured foam. It may also be desirable to introduce a physical blowing agent into the froth to further reduce foam density during the crosslinking process. In another embodiment, the polyurethane foam is formed from the reactive composition using only physical or chemical blowing agents, without the used of any mechanical frothing.

The organic polyisocyanates used in the preparation of electromagnetically shielding and/or electrostatically dissipative polyurethane elastomers or foams generally comprises isocyanates having the general formula:
Q(NCO)ᵢ
wherein i is an integer of two or more and Q is an organic radical having the valence of i, wherein i has an average value greater than 2. Q may be a substituted or unsubstituted hydrocarbon group (i.e., an alkylene or an arylene group),or a group having the formula Q¹-Z-Q¹ wherein Q¹ is an alkylene or arylene group and Z is —O—, —O-Q¹-S, —CO—, —S—, —S-Q⁴⁰ -S—, —SO—, —SO₂—, alkylene or arylene. Examples of such polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, and polymeric isocyanates such as polymethylene polyphenylisocyanate.

Q may also represent a polyurethane radical having a valence of i in which case Q(NCO)ᵢ is a composition known as a prepolymer. Such prepolymers are formed by reacting a stoichiometric excess of a polyisocyanate as above with an active hydrogen-containing component, especially the polyhydroxyl-containing materials or polyols described below. Usually, for example, the polyisocyanate is employed in proportions of about 30 percent to about 200 percent stoichiometric excess, the stoichiometry being based upon equivalents of isocyanate group per equivalent of hydroxyl in the polyol. The amount of polyisocyanate employed will vary slightly depending upon the nature of the polyurethane being prepared.

The active hydrogen-containing component may comprise polyether polyols and polyester polyols. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, and castor oil polyols. Suitable dicarboxylic acids and derivatives of dicarboxylic acids which are useful for producing polycondensation polyester polyols are aliphatic or cycloaliphatic dicarboxylic acids such as glutaric, adipic, sebacic, fumaric and maleic acids; dimeric acids; aromatic dicarboxylic acids such as, but not limited to phthalic, isophthalic and terephthalic acids; tribasic or higher functional polycarboxylic acids such as pyromellitic acid; as well as anhydrides and second alkyl esters, such as, but not limited to maleic anhydride, phthalic anhydride and dimethyl terephthalate.

Additional active hydrogen-containing components are the polymers of cyclic esters. The preparation of cyclic ester polymers from at least one cyclic ester monomer is well documented in the patent literature as exemplified by U.S. Pat. Nos. 3,021,309 through 3,021,317; 3,169,945; and 2,962,524. Suitable cyclic ester monomers include, but are not limited to δ-valerolactone, ε-caprolactone, zeta-enantholactone, the monoalkyl-valerolactones, e.g., the monomethyl-, monoethyl-, and monohexyl-valerolactones. In general the polyester polyol may comprise caprolactone based polyester polyols, aromatic polyester polyols, ethylene glycol adipate based polyols, and mixtures comprising any one of the foregoing polyester polyols. Polyester polyols made from ε-caprolactones, adipic acid, phthalic anhydride, terephthalic acid or dimethyl esters of terephthalic acid are generally preferred.

The polyether polyols are obtained by the chemical addition of alkylene oxides, such as ethylene oxide, propylene oxide and mixtures thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy)methyl]-ethane, 1,1,1-tris[2-hydroxypropoxy)-methyl]propane, diethylene glycol, dipropylene glycol, pentaerythritol, sorbitol, sucrose, lactose, alpha-methylglucoside, alpha-hydroxyalkylglucoside, novolac resins, phosphoric acid, benzenephosphoric acid, polyphosphoric acids such as tripolyphosphoric acid and tetrapolyphosphoric acid, ternary condensation products, and the like. The alkylene oxides employed in producing polyoxyalkylene polyols normally have from 2 to 4 carbon atoms. Propylene oxide and mixtures of propylene oxide with ethylene oxide are preferred. The polyols listed above may be used per se as the active hydrogen component.

A preferred class of polyether polyols is represented generally by the following formula
R[(OCₙH₂ₙ)_{z}OH]ₐ
wherein R is hydrogen or a polyvalent hydrocarbon radical; a is an integer (i.e., 1 or 2 to 6 to 8) equal to the valence of R, n in each occurrence is an integer from 2 to 4 inclusive (preferably 3) and z in each occurrence is an integer having a value of from 2 to about 200, preferably from 15 to about 100. The preferred polyether polyol comprises a mixture of one or more of dipropylene glycol, 1,4-butanediol, 2-methyl-1,3-propanediol, or the like, or combinations comprising at least one of the foregoing polyether polyols.

Other types of active hydrogen-containing materials which may be utilized are polymer polyol compositions obtained by polymerizing ethylenically unsaturated monomers in a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride and other ethylenically unsaturated monomers as identified and described in the above-mentioned U.S. patent. Suitable polyols include those listed and described hereinabove and in U.S. Pat. No. 3,383,351. The polymer polyol compositions may contain from greater than or equal to about 1, preferably greater than or equal to about 5, and more preferably greater than or equal to about 10 wt % monomer polymerized in the polyol where the weight percent is based on the total amount of polyol. It is also generally desirable for the polymer polyol compositions to contain less than or equal to about 70, preferably less than or equal to about 50, more preferably less than or equal to about 40 wt % monomer polymerized in the polyol. Such compositions are conveniently prepared by polymerizing the monomers in the selected polyol at a temperature of 40° C. to 150° C. in the presence of a free radical polymerization catalyst such as peroxides, persulfates, percarbonate, perborates, and azo compounds.

The active hydrogen-containing component may also contain polyhydroxyl-containing compounds, such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Pat. No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The polyols may have hydroxyl numbers that vary over a wide range. In general, the hydroxyl numbers of the polyols, including other cross-linking additives, if employed, may range in an amount of about 28 to about 1000, and higher, preferably about 100 to about 800. The hydroxyl number is defined as the number of milligrams of potassium hydroxide used for the complete neutralization of the hydrolysis product of the fully acetylated derivative prepared from 1 gram of polyol or mixtures of polyols with or without other cross-linking additives. The hydroxyl number may also be defined by the equation:

$$OH = \frac{56.1 \times 1000 \times f}{M . W .}$$

wherein OH is the hydroxyl number of the polyol, η is the average functionality, that is the average number of hydroxyl groups per molecule of polyol, and M. W. is the average molecular weight of the polyol.

Where used, a large number of suitable blowing agents or a mixture of blowing agents are suitable, particularly water. The water reacts with the isocyanate component to yield CO₂ gas, which provides the additional blowing necessary. It is generally desirable to control the curing reaction by selectively employing catalysts, when water is used as the blowing agent. Alternatively, compounds that decompose to liberate gases (e.g., azo compounds) may be also be used.

Especially suitable blowing agents are physical blowing agents comprising hydrogen atom-containing components, which may be used alone or as mixtures with each other or with another type of blowing agent such as water or azo compounds. These blowing agents may be selected from a broad range of materials, including hydrocarbons, ethers, esters and partially halogenated hydrocarbons, ethers and esters, and the like. Typical physical blowing agents have a boiling point between about −50° C. and about 100° C., and preferably between about −50° C. and about 50° C. Among the usable hydrogen-containing blowing agents are the HCFC's(halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; the HFE's(halo fluoroethers) such as methyl-1,1,1-trifluoroethylether and difluoromethyl-1,1,1-trifluoroethylether; and the hydrocarbons such as n-pentane, isopentane, and cyclopentane.

When used, the blowing agents including water generally comprise greater than or equal to 1, preferably greater than or equal to 5 weight percent (wt %) of the polyurethane liquid phase composition. In general, it is desirable to have the blowing agent present in an amount of less than or equal to about 30, preferably less than or equal to 20 wt % of the polyurethane liquid phase composition. When a blowing agent has a boiling point at or below ambient temperature, it is maintained under pressure until mixed with the other components.

Suitable catalysts used to catalyze the reaction of the isocyanate component with the active hydrogen-containing component are known in the art, and are exemplified by organic and inorganic acid salts of, and organometallic derivatives of bismuth, lead, tin, iron, antimony, uranium, cadmium, cobalt, thorium, aluminum, mercury, zinc, nickel, cerium, molybdenum, vanadium, copper, manganese, and zirconium, as well as phosphines and tertiary organic amines. Examples of such catalysts are dibutytin dilaurate, dibutyltin diacetate, stannous octoate, lead octoate, cobalt naphthenate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris(N,N-dimethylaminopropyl)-s-hexahydrotriazine, o- and p-(dimethylaminomethyl)phenols, 2,4,6-tris(dimethylaminomethyl) phenol, N,N-dimethylcyclohexylamine, pentamethyldiethylenetriamine, 1,4-diazobicyclo[2.2.2]octane, N-hydroxyl-alkyl quaternary ammonium carboxylates and tetramethylammonium formate, tetramethylammonium acetate, tetramethylammonium 2-ethylhexanoate and the like, as well as compositions comprising any one of the foregoing catalysts.

Metal acetyl acetonates are preferred, based on metals such as aluminum, barium, cadmium, calcium, cerium (III), chromium (III), cobalt (III), cobalt (III), copper (II), indium, iron (II), lanthanum, lead (II), manganese (II), manganese (II), neodymium, nickel (II), palladium (II), potassium, samarium, sodium, terbium, titanium, vanadium, yttrium, zinc and zirconium. A common catalyst is bis(2,4-pentanedionate) nickel (II) (also known as nickel acetylacetonate or diacetylacetonate nickel) and derivatives thereof such as diacetonitrilediacetylacetonato nickel, diphenylnitrilediacetylacetonato nickel, bis(triphenylphosphine)diacetyl acetylacetonato nickel, and the like. Ferric acetylacetonate (FeAA) is particularly preferred, due to its relative stability, good catalytic activity, and lack of toxicity. The metal acetylacetonate is most conveniently added by predissolution in a suitable solvent such as dipropylene glycol or other hydroxyl containing components which will then participate in the reaction and become part of the final product.

In a preferred method of producing the polyurethane foams, the components for producing the foams, i.e., the isocyanate component, the active hydrogen-containing component, surfactant, catalyst, optional blowing agents, electrically conductive, flame retardant filler and other additives are first mixed together then subjected to mechanical frothing with air. Alternatively, the ingredients may be added sequentially to the liquid phase during the mechanical frothing process. The gas phase of the froths is most preferably air because of its cheapness and ready availability. However, if desired, other gases may be used which are gaseous at ambient conditions and which are substantially inert or non-reactive with any component of the liquid phase. Such other gases include, for example, nitrogen, carbon dioxide, and fluorocarbons that are normally gaseous at ambient temperatures. The inert gas is incorporated into the liquid phase by mechanical beating of the liquid phase in high shear equipment such as in a Hobart mixer or an Oakes mixer. The gas may be introduced under pressure as in the usual operation of an Oakes mixer or it may be drawn in from the overlying atmosphere by the beating or whipping action as in a Hobart mixer. The mechanical beating operation preferably is conducted at pressures not greater than 7 to 14 kg/cm² (100 to 200 pounds per square inch (p.s.i.)). Readily available mixing equipment may be used and no special equipment is generally necessary. The amount of inert gas beaten into the liquid phase is controlled by gas flow metering equipment to produce a froth of the desired density. The mechanical beating is conducted over a period of a few seconds in an Oakes mixer, or about 3 to about 30 minutes in a Hobart mixer, or however long it takes to obtain the desired froth density in the mixing equipment employed. The froth as it emerges from the mechanical beating operation is substantially chemically stable and is structurally stable but easily workable at ambient temperatures, e.g., about 10° C. to about 40° C.

The mechanical froth is then laid out on a conveyor belt or a sample holder and placed in an oven at the desired temperature to undergo cure. During this process, the blowing agents may be activated. Curing takes place simultaneously to produce foam that has a desired density and other physical properties.

In a preferred method of preparation of electrically conductive polyurethane elastomers, the components listed above, with the exception of the blowing agent, are mixed together without frothing and cast onto a substrate such as a conveyor belt. A doctor blade may be used to adjust the dimensions of the cast mixture prior to curing.

Preferably, the electrically conductive polyurethane foam and elastomer has mechanical properties similar to those of the same polyurethane foam and elastomer without the coated flame retardant particles. Desirable properties for an electrically conductive polyurethane foam are a 25% compressive force deflection (CFD) of about 0.007 to about 10.5 kg/cm² (about 0.1 to about 150 psi), an elongation to break of greater than or equal to about 20%, a compression set (50%) of less than or equal to about 30%, and a bulk density of about 1 to about 50 pcf. If auxiliary blowing agents are employed, the resultant foam may have a bulk density as low as about 1 pcf.

Desirable properties for an electrically conductive polyurethane elastomer are an elongation to break of greater than or equal to about 20%, a Shore A Durometer of less than or equal to about 80, and a compression set (50%) of less than or equal to about 30.

Polyolefins may also be used to provide electrically conductive foams and elastomers, particularly foams and elastomers having electromagnetic shielding and/or electrostatic dissipative properties. In general, the polyolefin foams are produced by extrusion, where a blowing agent and a crosslinking agent are incorporated into the melt. Crosslinking may be by irradiation, peroxide, or moisture-induced condensation of a silane, followed by blowing of the foam, which generally occurs outside the extruder upon the removal of pressure. Additional heating may be used outside the extruder to facilitate the blowing and curing reactions. Polyolefin elastomers, on the other hand, generally do not utilize any significant amount of blowing agent prior to curing.

Suitable polyolefins used in the manufacture of foams and elastomers include linear low density polyethylene (LLDPE), low density polyethylene (LDPE), high density polyethylene (HDPE), very low density polyethylene (VLDPE), ethylene vinyl acetate (EVA), polypropylene (PP), ethylene vinyl alcohol (EVOH), EPDM, EPR, and combinations comprising at least one of the foregoing polyolefins.

Polyolefins used in the manufacture of foams and elastomers may be obtained by Zeigler-Natta based polymerization processes or by single site initiated (metallocene catalysts) polymerization processes may also be used. Preferred polyolefins used in the electromagnetically shielding and/or electrostatically dissipative and/or electrically conductive foams and elastomers are those obtained from metallocene catalysts and in particular those obtained from single site catalysts. Common examples of single site catalysts used for the production of polyolefins are alumoxane, and group IV B transition metals such as zirconium, titanium, or hafnium. The preferred polyolefins for use in the foams and elastomers are of a narrow molecular weight distribution and are “essentially linear”. The term essentially linear as defined herein refers to a “linear polymer” with a molecular backbone which is virtually devoid of “long-chain branching,” to the extent that it possess less than or equal to about 0.01 “long-chain branches” per one-thousand carbon atoms. As a result of this combination, the resins exhibit a strength and toughness approaching that of linear low density polyethylenes, but have processability similar to high pressure reactor produced, low density polyethylene.

The preferred “essentially linear” polyolefin resins are characterized by a resin density of about 0.86 gram/cubic centimeter (g-cm⁻³) to about 0.96 g-cm⁻³, a melt index of about 0.5 decigram/minute (dg/min) to about 100 dg/min at a temperature of 190° C. and a force of 2.10 kilogram (kg) as per ASTM D 1238, a molecular weight distribution of about 1.5 to about 3.5, and a composition distribution breadth index greater than or equal to about 45 percent. The composition distribution breadth index (CDBI) is a measurement of the uniformity of distribution of comonomer to the copolymer molecules, and is determined by the technique of Temperature Rising Elution Fractionation (TREF). As used herein, the CDBI is defined as the weight percent of the copolymer molecules having a comonomer content within 50% (i.e., plus or minus 50%) of the median total molar comonomer content. Unless otherwise indicated, terms such as “comonomer content,” “average comonomer content” and the like refer to the bulk comonomer content of the indicated interpolymer blend, blend component or fraction on a molar basis. For reference, the CDBI of linear poly(ethylene), which is absent of comonomer, is defined to be 100%.

The preferred essentially linear olefin is a copolymer resin of a polyethylene. The essentially linear olefinic copolymers of the present invention are preferably derived from ethylene polymerized with at least one comonomer selected from the group consisting of at least one alpha-unsaturated C₃ to C₂₀ olefin comonomer, and optionally one or more C₃ to C₂₀ polyene.

Generally, the alpha-unsaturated olefin comonomers suitable for use in the foams and elastomers have about 3 to about 20 carbon atoms. Within this range it is generally desirable to have alpha-unsaturated comonomers containing greater than or equal to about 3 carbon atoms. Also desirable within this range are alpha-unsaturated comonomers containing less than or equal to about 16, and preferably less than 8 carbon atoms. Examples of such alpha-unsaturated olefin comonomers used as copolymers with ethylene include propylene, isobutylene, 1 -butene, 1 -hexene, 3-methyl-1-pentene, 4-methyl-1-pentene, 1-octene, 1-decene, 1-dodecene, styrene, halo- or alkyl-substituted styrene, tetrafluoroethylene, vinyl cyclohexene, vinyl-benzocyclobutane and the like.

The polyenes are straight chain, branched chain, or cyclic hydrocarbon dienes having about 3 to about 20 carbon atoms. It is generally desirable for the polyenes to have greater than or equal to about 4, preferably greater than or equal to about 6 carbon atoms. Also desirable within this range, is an amount of less than or equal to about 15 carbon atoms. It is also preferred that the polyene is non-conjugated diene. Examples of such dienes include 1,3-butadiene, 1,4-hexadiene, 1,6-octadiene, 5-methyl-1,4-hexadiene, 3,7-dimethyl-1,6-octadiene, 3,7-dimethyl-1,7-octadiene, 5-ethylidene-2-norbomene, and dicyclopentadiene. A preferred diene is 1,4-hexadiene.

Preferably, the polyolefin foams or elastomers comprise either ethylene/alpha-unsaturated olefin copolymers or ethylene/alpha-unsaturated olefin/diene terpolymers. Most preferably, the essentially linear copolymer will comprise ethylene and 1-butene or ethylene and 1-hexene. It is generally desirable to have the comonomer content of the olefin copolymers at about 1 mole percent to about 32 mole percent based on the total moles of monomer. Within this range it is generally desirable to have the comonomer content greater than or equal to about 2, preferably greater than or equal to about 6 mole percent based upon the total moles of monomer. Also desirable within this range is a comonomer content of less than or equal to about 26, preferably less than or equal to about 25 mole percent based on the total moles of monomer.

Suitable polyolefins are produced commercially by Exxon Chemical Company, Baytown, Tex., under the trade name EXACT, and include EXACT 3022, EXACT™ 3024, EXACT™ 3025, EXACT™ 3027, EXACT™ 3028, EXACT™ 3031, EXACT™ 3034, EXACT™ 3035, EXACT™ 3037, EXACT™ 4003, EXACT™ 4024, EXACT™ 4041, EXACT™ 4049, EXACT™ 4050, EXACT™ 4051, EXACT™ 5008, and EXACT™ 8002. Other olefin copolymers are available commercially from Dow Plastics, Midland, Michigan (or DuPont/Dow), under trade names such as ENGAGE and AFFINITY and include CL8001, CL8002, EG8100, EG8150, PL1840, PL1845 (or DuPont/Dow 8445), EG8200, EG8180, GF1550, KC8852, FW1650, PL1880, HF1030, PT1409, CL8003, and D8130 (or XU583-00-01).

While the aforementioned essentially linear olefin polymers and copolymers are most preferred, the addition of other polymers or resins to the composition may result in certain advantages in the economic, physical, and handling characteristics of the cellular articles. Examples of suitable additive polymers include polystyrene, polyvinyl chloride, polyamides, polyacrylics, cellulosics, polyesters, and polyhalocarbons. Copolymers of ethylene with propylene, isobutene, butene, hexene, octene, vinyl acetate, vinyl chloride, vinyl propionate, vinyl isobutyrate, vinyl alcohol, allyl alcohol, allyl acetate, allyl acetone, allyl benzene, allyl ether, ethyl acrylate, methyl acrylate, methyl methacrylate, acrylic acid, and methacrylic acid may also be used. Various polymers and resins which find wide application in peroxide-cured or vulcanized rubber articles may also be added, such as polychloroprene, polybutadiene, polyisoprene, poly(isobutylene), nitrile-butadiene rubber, styrene-butadiene rubber, chlorinated polyethylene, chlorosulfonated polyethylene, epichlorohydrin rubber, polyacrylates, butyl or halo-butyl rubbers, or the like, or combinations comprising at least one of the foregoing polymers and resins. Other resins including blends of the above materials may also be added to the polyolefin foams and elastomers.

A preferred polyolefin blend (particularly for use as an elastomer) comprises a single-site initiated polyolefin resin having a density of less than or equal to about 0.878 g-cm⁻³ and less than or equal to about 40 weight percent of a polyolefin comprising ethylene and propylene wherein the weight percents are based upon the total composition. At least a portion of the blend is cross-linked to form an elastomer if desired. The elastomer may be used as a gasket if desired and is generally thermally stable at 48° C. (120° F.). A preferred polyolefin comprising ethylene and propylene is EPR, even more preferably EPDM. The polyolefin blend preferably has greater than or equal to about 5 wt % of the single-site initiated polyolefin resin and greater than or equal to about 5 wt % of the polyolefin that comprises ethylene and propylene.

In addition to the single site initiated polyolefin resin having a density of less than or equal to about 0.878 g-cm⁻³ and the polyolefin comprising ethylene and propylene, the polymer blend may contain less than or equal to about 70 wt % of other polymer resins such as low density polyethylene, high density polyethylene, linear low density polyethylene, polystyrene, polyvinyl chloride, polyamides, polyacrylics, celluloses, polyesters, and polyhalocarbons. Copolymers of ethylene with propylene, isobutene, butene, hexene, octene, vinyl acetate, vinyl chloride, vinyl propionate, vinyl isobutyrate, vinyl alcohol, allyl alcohol, allyl acetate, allyl acetone, allyl benzene, allyl ether, ethyl acrylate, methyl acrylate, methyl methacrylate, acrylic acid, and methacrylic acid may also be used. Various polymers and resins which find wide application in peroxide-cured or vulcanized rubber articles may also be added, such as polychloroprene, polybutadiene, polyisoprene, poly(isobutylene), nitrile-butadiene rubber, styrene-butadiene rubber, chlorinated polyethylene, chlorosulfonated polyethylene, epichlorohydrin rubber, polyacrylates, butyl or halo-butyl rubbers, or the like, or combinations comprising at least foregoing polymer resins.

The polyolefins foams and elastomers may or may not be crosslinked. Cross-linking of polyolefinic materials with any additional polymers such as, for example, those listed above, may be effected through several known methods including: (1) use of free radicals provided through the use of organic peroxides or electron beam irradiation; (2) sulfur cross-linking in standard EPDM (rubber) curing; (3) and moisture curing of silane-grafted materials. The cross-linking methods may be combined in a co-cure system or may be used individually crosslink the elastomeric or foamed compositions. In the case of polyolefinic foams, the cross-linking of the foamed compositions aids in the formation of desirable foams and also leads to the improvement of the ultimate physical properties of the materials. The level of cross-linking in the material may be adjusted to vary the mechanical properties of the foam. The silane-grafting, cross-linking mechanism is particularly advantageous because it provides a change in the polymer rheology by producing a new structure having improved mechanical properties. In one embodiment, crosslinking of the polyolefin foam or elastomer may be achieved through the use of ethylenically unsaturated functionalities grafted onto the chain backbone of the essentially linear polyolefin.

Suitable chemical cross-linking agents include, but are not limited to, organic peroxides, preferably alkyl and aralkyl peroxides. Examples of such peroxides include: dicumylperoxide, 2,5-dimethyl-2,5-di(t-butylperoxy)hexane, 1,1-bis(t-butylperoxy)-3,3,5-trimethylcyclohexane, 1,1-di-(t-butylperoxy)-cyclohexane, 2,2′-bis(t-butylperoxy)diisopropylbenzene, 4,4′-bis(t-butylperoxy)butylvalerate, t-butyl-perbenzoate, t-butylperterephthalate, and t-butyl peroxide. Most preferably, the cross-linking agent is dicumyl peroxide (Dicup) or 2,2′-bis(t-butylperoxy)diisopropylbenzene (Vulcup).

Chemically cross-linked compositions are improved upon with the addition of multi-functional monomeric species, often referred to as “coagents”. Illustrative, but non-limiting, examples of coagents suitable for use in chemical cross-linking include di- and tri-allyl cyanurates and isocyanurates, alkyl di- and tri-acrylates and methacrylates, zinc-based dimethacrylates and diacrylates, and 1,2-polybutadiene resins.

Preferred agents used in the silane graffing of the polyolefin foams and elastomers are the azido-functional silanes of the general formula RR′SiY₂, in which R represents an azido-functional radical attached to silicon through a silicon-to-carbon bond and composed of carbon, hydrogen, optionally sulfur and oxygen; each Y represents a hydrolyzable organic radical; and R′ represents a monovalent hydrocarbon radical or a hydrolyzable organic radical. Azido-silane compounds are grafted onto an olefinic polymer though a nitrene insertion reaction. Cross-linking develops through hydrolysis of the silanes to silanols followed by condensation of silanols to siloxanes. Certain metal soap catalysts such as dibutyl tin dilaurate or butyl tin maleate and the like catalyze the condensation of silanols to siloxanes. Suitable azido-functional silanes include the trialkoxysilanes such as 2-(trimethoxylsilyl)ethyl phenyl sulfonyl azide and (triethoxysilyl)hexyl sulfonyl azide.

Other suitable silane cross-linking agents include vinyl functional alkoxy silanes such as vinyl trimethoxy silane and vinyl trimethoxy silane. These silane cross-linking agents may be represented by the general formula RR′SiY₂ in which R represents a vinyl functional radical attached to silicon through a silicon-carbon bond and composed of carbon, hydrogen, and optionally oxygen or nitrogen, each Y represents a hydrolyzable organic radical, and R′ represents a hydrocarbon radical or Y. When silane cross-linking agents are used, water is generally added during the processing in order to facilitate cross-linking. It is generally desirable to use a silane-grafted essentially linear olefin copolymer resin having a silane-graft content of less than or equal to about 6 wt % of the total weight of the composition. Within this range, it is generally preferably to have a silane graft content of greater than or equal to about 0.1 wt % of the total weight of the composition. Also desirable within this range is a silane graft content of less than or equal to about 2 wt % of the total weight of the composition. The silane may include a vinyl silane having a C₂ to C₁₀ alkoxy group. It is generally desirable to use a vinyl silane having 2 or 3 hydrolyzable groups, wherein the hydrolyzable groups are C₂-C₁₀ alkoxy groups. Most preferably, the silane includes vinyl triethoxysilane. In foamed polyolefin articles, the silane includes a vinyl silane having a C₁ to C₁₀ alkoxy group.

The expanding medium or blowing agents used to produce polyolefin foams may be normally gaseous, liquid, or solid compounds or elements, or mixtures thereof. In a general sense, these blowing agents may be characterized as either physically expanding or chemically decomposing. Of the physically expanding blowing agents, the term “normally gaseous” is intended to mean that the blowing agent employed is a gas at the temperatures and pressures encountered during the preparation of the foamable compound, and that this medium may be introduced either in the gaseous or liquid state as convenience would dictate.

Included among the normally gaseous and liquid blowing agents are the halogen derivatives of methane and ethane, such as methyl fluoride, methyl chloride, difluoromethane, methylene chloride, perfluoromethane, trichloromethane, difluoro-chloromethane, dichlorofluoromethane, dichlorodifluoromethane (CFC-12), trifluorochloromethane, trichloromonofluoromethane (CFC-11), ethyl fluoride, ethyl chloride, 2,2,2-trifluoro-1,1-dichloroethane (HCFC-123), 1,1,1-trichloroethane, difluorotetrachloroethane, 1,1-dichloro-1-fluoroethane (HCFC-141b), 1,1-difluoro-1-chloroethane (HCFC-142b), dichlorotetrafluoroethane (CFC-114), chlorotrifluoroethane, trichlorotrifluoroethane (CFC-113), 1-chloro-1,2,2,2-tetrafluoroethane (HCFC-124), 1,1-difluoroethane (HFC-152a), 1,1,1-trifluoroethane (HFC-143a), 1,1,1,2-tetrafluoroethane (HFC-134a), perfluoroethane, pentafluoroethane, 2,2-difluoropropane, 1,1,1-trifluoropropane, perfluoropropane, dichloropropane, difluoropropane, chloroheptafluoropropane, dichlorohexafluoropropane, perfluorobutane, perfluorocyclobutane, sulfur-hexafluoride, and mixtures thereof. Other normally gaseous and liquid blowing agents that may be employed are hydrocarbons and other organic compounds such as acetylene, ammonia, butadiene, butane, butene, isobutane, isobutylene, dimethylamine, propane, dimethylpropane, ethane, ethylamine, methane, monomethylamine, trimethylamine, pentane, cyclopentane, hexane, propane, propylene, alcohols, ethers, ketones, and the like. Inert gases and compounds, such as carbon dioxide, nitrogen, argon, neon, or helium, may be used as blowing agents with satisfactory results. A physical blowing agent may be used to produce foam directly out of the extrusion die. The composition may optionally include chemical foaming agents for further expansion.

Solid, chemically decomposable foaming agents, which decompose at elevated temperatures to form gasses, may be used. In general, the decomposable foaming agent will have a decomposition temperature (with the resulting liberation of gaseous material) of about 130° C. to about 350° C. Representative chemical foaming agents include azodicarbonamide, p,p′-oxybis(benzene)sulfonyl hydrazide, p-toluene sulfonyl hydrazide, p-toluene sulfonyl semicarbazide, 5-phenyltetrazole, ethyl-5-phenyltetrazole, dinitroso pentamethylenetetramine, and other azo, N-nitroso, carbonate and sulfonyl hydrazides as well as various acid/bicarbonate compounds which decompose when heated.

In the production of electrically conductive polyolefin foams, the polyolefin resins, electrically conductive, flame retardant filler, physical blowing agents, crosslinking agents, initiators and other desired additives are fed into an extruder. Alternatively, it may be possible for the blowing agents such as liquid carbon dioxide or supercritical carbon dioxide to be pumped into the extruder further downstream. When physical blowing agents are pumped into extruder it is desirable for the melt in the extruder to be maintained at a certain pressure and temperature, to facilitate the solubility of the blowing agent into the melt, and also to prevent foaming of the melt within the extruder. The electrically conductive, flame retardant filler may also be added to the extruder further downstream either directly or in masterbatch form. The extrudate upon emerging from the mixer will start to foam. The density of the foam is dependent upon the solubility of the physical blowing agent within the melt, as well as the pressure and temperature differential between the extruder and the outside. If solid-state chemical blowing agents are used, then the foam density will depend upon the amount of the chemical blowing agents used. In order to effect complete blowing of the polyolefin foam, the extrudate may be further processed in high temperature ovens where radio frequency heating, microwave heating, and convectional heating may be combined.

In the production of thermosetting electrically conductive polyolefin foams, it is generally desirable to first crosslink the composition, prior to subjecting it to foaming at higher temperatures. The foaming at higher temperatures may be accomplished by radio frequency heating, microwave heating, convectional heating, or a combination comprising at least one of the foregoing methods of heating.

In the production of electrically conductive polyolefin elastomers, the above-described components (with the exception of the blowing agents) are generally added to a mixing device such as a Banbury, a roll mill or and extruder in order to intimately mix the components. Curing of the polyolefin elastomer may begin during the mixing process and may continue after the mixing is completed. In certain instances, it may be desirable to subject the elastomer to a post-curing step after the mixing. Post-curing may be accomplished in a separate convectional oven or may be carried out online using convectional ovens and electromagnetic heating (e.g., radio frequency heating, microwave heating, or the like).

Preferably, the electrically conductive polyolefin foams have mechanical properties similar to those of the same polyolefin foam without electrically conductive, flame retardant filler. Desirable properties include a density of about 1 to about 20 pcf, a 25% CFD of about 0.25 to about 40 psi, an elongation to break of greater than or equal to about 50%, and a compression set of less than or equal to about 70%.

The electrically conductive polyolefin elastomers preferably have mechanical properties that are the same as, or similar to the same polyolefin elastomer without electrically conductive, flame retardant filler. Desirable properties for a polyolefin elastomer include a Shore A durometer of less than or equal to about 80, preferably less than or equal to about 40, and an elongation to break of greater than or equal to about 50%.

Silicone foams and elastomers comprising a polysiloxane polymer and electrically conductive, flame retardant filler may also be advantageously utilized to provide electrically conductive compositions, particularly electromagnetic shielding and/or electrostatically dissipative.

The silicone foams are generally produced as a result of the reaction between water and hydride groups on the polysiloxane polymer with the consequent liberation of hydrogen gas. This reaction is generally catalyzed by a noble metal, preferably a platinum catalyst. The polysiloxane polymer used in the foams or the elastomers generally has a viscosity of about 100 to 1,000,000 poise at 25° C. and has chain substituents selected from the group consisting of hydride, methyl, ethyl, propyl, vinyl, phenyl, and trifluoropropyl. The end groups on the polysiloxane polymer may be hydride, hydroxyl, vinyl, vinyl diorganosiloxy, alkoxy, acyloxy, allyl, oxime, aminoxy, isopropenoxy, epoxy, mercapto groups, or other known, reactive end groups. Suitable silicone foams may also be produced by using several polysiloxane polymers, each having different molecular weights (e.g., bimodal or trimodal molecular weight distributions) as long as the viscosity of the combination lies within the above specified values. It is also possible to have several polysiloxane base polymers with different functional or reactive groups in order to produce the desired foam. It is generally desirable to have about 0.2 moles of hydride (Si—H) groups per mole of water.

Depending upon the chemistry of the polysiloxane polymers used, a catalyst, generally platinum or a platinum-containing catalyst, may be used to catalyze the blowing and the curing reaction. The catalyst may be deposited onto an inert carrier, such as silica gel, alumina, or carbon black. Preferably, an unsupported catalyst selected from among chloroplatinic acid, its hexahydrate form, its alkali metal salts, and its complexes with organic derivatives is used. Particularly recommended are the reaction products of chloroplatinic acid with vinylpolysiloxanes such as 1,3-divinyltetramethyldisiloxane, which are treated or otherwise with an alkaline agent to partly or completely remove the chlorine atoms as described in U.S. Pat. Nos. 3,419,593; 3,775,452 and 3,814,730; the reaction products of chloroplatinic acid with alcohols, ethers, and aldehydes as described in U.S. Pat. No. 3,220,972; and platinum chelates and platinous chloride complexes with phosphines, phosphine oxides, and with olefins such as ethylene, propylene, and styrene as described in U.S. Pat. Nos. 3,159,601 and 3,552,327. It may also be desirable, depending upon the chemistry of the polysiloxane polymers to use other catalysts such as dibutyl tin dilaurate in lieu of platinum based catalysts.

Various platinum catalyst inhibitors may also be used to control the kinetics of the blowing and curing reactions in order to control the porosity and density of the silicone foams. Common examples of such inhibitors are polymethylvinylsiloxane cyclic compounds and acetylenic alcohols. These inhibitors should not interfere with the foaming and curing in such a manner that destroys the foam.

Physical or chemical blowing agents may be used to produce the silicone foam, including the physical and chemical blowing agents listed above for polyurethanes or polyolefins. Under certain circumstances it may be desirable to use a combination of methods of blowing to obtain foams having desirable characteristics. For example, a physical blowing agent such as a chlorofluorocarbon may be added as a secondary blowing agent to a reactive mixture wherein the primary mode of blowing is the hydrogen released as the result of the reaction between water and hydride substituents on the polysiloxane.

In the production of silicone foams, the reactive components are generally stored in two packages, one containing the platinum catalyst and the other the polysiloxane polymer containing hydride groups, which prevents premature reaction. It is possible to include the conductive, flame retardant particles in either package. In another method of production, the polysiloxane polymer may introduced into an extruder along with the electrically conductive, flame retardant filler, water, physical blowing agents if necessary and other desirable additives. The platinum catalyst is then metered into the extruder to start the foaming and curing reaction. The use of physical blowing agents such as liquid carbon dioxide or supercritical carbon dioxide in conjunction with chemical blowing agents such as water may give rise to foam having much lower densities. In yet another method, the liquid silicone components are metered, mixed and dispensed into a device such a mold or a continuous coating line. The foaming then occurs either in the mold or on the continuous coating line.

Preferably, the electrically conductive silicone foams have mechanical properties that are the same or similar to those of the same silicone foams without the electrically conductive, flame retardant filler. Desirable properties include a density of about 1 to about 40 pcf, a 25% CFD of about 0.1 to about 80 psi, an elongation to break of about greater than 20% and a compression set of less than about 15%.

A soft, electrically conductive silicone elastomer may be formed by the reaction of a liquid silicone composition comprising a polysiloxane having at least two alkenyl groups per molecule; a polysiloxane having at least two silicon-bonded hydrogen atoms in a quantity effective to cure the composition; a catalyst, electrically conductive, flame retardant filler; and optionally a reactive or non-reactive polysiloxane fluid having a viscosity of about 100 to about 1000 centipoise. Suitable reactive silicone compositions are low durometer, 1:1 liquid silicone rubber (LSR) or liquid injection molded (LIM) compositions. Because of their low inherent viscosity, the use of the low durometer LSR or LIM facilitates the addition of higher filler quantities, and results in formation of a low durometer elastomer or foam.

The reactive or non-reactive polysiloxane fluid allows higher quantities of filler to be incorporated into the cured silicone composition, thus lowering the obtained volume and surface resistivity values. It is generally desirable for the polysiloxane fluid to remain within the cured silicone and not to be extracted or removed. The reactive silicone fluid thus becomes part of the polymer matrix, leading to low outgassing and little or no migration to the surface during use. The boiling point of the non-reactive silicone fluid is preferably high enough such that when it is dispersed in the polymer matrix, it does not evaporate during or after cure, and does not migrate to the surface or outgas.

LSR or LIM systems are generally provided as two-part formulations suitable for mixing in ratios of about 1:1 by volume. The “A” part of the formulation generally contains one or more polysiloxanes having at least two alkenyl groups and has an extrusion rate of less than about 500 g/minute. Suitable alkenyl groups are exemplified by vinyl, allyl, butenyl, pentenyl, hexenyl, and heptenyl, with vinyl being particularly preferred. The alkenyl group can be bonded at the molecular chain terminals, in pendant positions on the molecular chain, or both. Other silicon-bonded organic groups in the polysiloxane having at least two alkenyl groups are exemplified by substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically preferred.

The alkenyl-containing polysiloxane can have straight chain, partially branched straight chain, branched-chain, or network molecule structure, or may be a mixture of two or more selections from polysiloxanes with the exemplified molecular structures. The alkenyl-containing polysiloxane is exemplified by trimethylsiloxy-endblocked dimethylsiloxane-methylvinylsiloxane copolymers, trimethylsiloxy-endblocked methylvinylsiloxane-methylphenylsiloxane copolymers, trimethylsiloxy-end blocked dimethylsiloxane-methylvinylsiloxane-methylphenylsiloxane copolymers, dimethylvinylsiloxy-endblocked dimethylpolysiloxanes, dimethylvinylsiloxy-endblocked methylvinylpolysiloxanes, dimethylvinylsiloxy-endblocked methylvinylphenylsiloxanes, dimethylvinylsiloxy-endblocked dimethylvinylsiloxane-methylvinylsiloxane copolymers, dimethylvinylsiloxy-endblocked dimethylsiloxane-methylphenylsiloxane copolymers, dimethylvinylsiloxy-endblocked dimethylsiloxane-diphenylsiloxane copolymers, polysiloxane comprising R₃SiO_{1/2} and SiO_{4/2} units, polysiloxane comprising RSiO_{3/2} units, polysiloxane comprising the R₂SiO_{2/2} and RSiO_{3/2} units, polysiloxane comprising the R₂SiO_{2/2}, RSiO_{3/2} and SiO_{4/2} units, and a mixture of two or more of the preceding polysiloxanes. R represents substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl, with the proviso that at least 2 of the R groups per molecule are alkenyl.

The B component of the LSR or LIM system generally contains one or more polysiloxanes that contain at least two silicon-bonded hydrogen atoms per molecule and has an extrusion rate of less than about 500 g/minute. The hydrogen can be bonded at the molecular chain terminals, in pendant positions on the molecular chain, or both. Other silicon-bonded groups are organic groups exemplified by non-alkenyl, substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically preferred.

The hydrogen-containing polysiloxane component can have straight-chain, partially branched straight-chain, branched-chain, cyclic, network molecular structure, or may be a mixture of two or more selections from polysiloxanes with the exemplified molecular structures. The hydrogen-containing polysiloxane is exemplified by trimethylsiloxy-endblocked methylhydrogenpolysiloxanes, trimethylsiloxy-endblocked dimethylsiloxane-methylhydrogensiloxane copolymers, trimethylsiloxy-endblocked methylhydrogensiloxane-methylphenylsiloxane copolymers, trimethylsiloxy-endblocked dimethylsiloxane-methylhydrogensiloxane-methylphenylsiloxane copolymers, dimethylhydrogensiloxy-endblocked dimethylpolysiloxanes, dimethylhydrogensiloxy-endblocked methylhydrogenpolysiloxanes, dimethylhydrogensiloxy-endblocked dimethylsiloxanes-methylhydrogensiloxane copolymers, dimethylhydrogensiloxy-endblocked dimethylsiloxane-methylphenylsiloxane copolymers, and dimethylhydrogensiloxy-endblocked methylphenylpolysiloxanes.

The hydrogen-containing polysiloxane component is added in an amount sufficient to cure the composition, preferably in a quantity of about 0.5 to about 10 silicon-bonded hydrogen atoms per alkenyl group in the alkenyl-containing polysiloxane.

The silicone composition further comprises, generally as part of Component B, a catalyst such as platinum to accelerate the cure. Platinum and platinum compounds known as hydrosilylation-reaction catalysts can be used, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of a platinum addition-reaction catalyst, as described above, in a thermoplastic resin such as methyl methacrylate, polycarbonate, polystyrene, silicone, and the like. Mixtures of catalysts may also be used. An quantity of catalyst effective to cure the present composition is generally from 0.1 to 1,000 parts per million (by weight) of platinum metal based on the combined amounts of alkenyl and hydrogen components.

The composition optionally further comprises one or more polysiloxane fluids having a viscosity of less than or equal to about 1000 centipoise, preferably less than or equal to about 750 centipoise, more preferably less than or equal to about 600 centipoise, and most preferably less than or equal to about 500 centipoise. The polysiloxane fluids may also have a have a viscosity of greater than or equal to about 100 centipoises. The polysiloxane fluid component is added for the purpose of decreasing the viscosity of the composition, thereby allowing at least one of increased filler loading, enhanced filler wetting, and enhanced filler distribution, and resulting in cured compositions having lower resistance and resistivity values. Use of the polysiloxane fluid component may also reduce the dependence of the resistance value on temperature, and/or reduce the timewise variations in the resistance and resistivity values. Use of the polysiloxane fluid component obviates the need for an extra step during processing to remove the fluid, as well as possible outgassing and migration of diluent during use. The polysiloxane fluid should not inhibit the curing reaction, i.e., the addition reaction, of the composition but it may or may not participate in the curing reaction.

The non-reactive polysiloxane fluid has a boiling point of greater than about 500° F. (260° C.), and may be branched or straight-chained. The non-reactive polysiloxane fluid comprises silicon-bonded non-alkenyl organic groups exemplified by substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically preferred. Thus, the non-reactive polysiloxane fluid may comprise R₃SiO_{1/2} and SiO_{4/2} units, RSiO_{3/2} units, R₂SiO_{2/2} and RSiO_{3/2} units, or R₂SiO_{2/2}, RSiO_{3/2} and SiO_{4/2} units, wherein R represents substituted and unsubstituted monovalent hydrocarbon groups selected from the group consisting of alkyl, methyl, ethyl, propyl, butyl, pentyl, hexyl, aryl, phenyl, tolyl, xylyl, aralkyl, benzyl, phenethyl, halogenated alkyl, 3-chloropropyl, and 3,3,3-trifluoropropyl. Because the non-reactive polysiloxane is a fluid and has a significantly higher boiling point (greater than about 230° C. (500° F.)), it allows the incorporation of higher quantities of filler, but does not migrate or outgas. Examples of non-reactive polysiloxane fluids include DC 200 from Dow Corning Corporation.

Reactive polysiloxane fluids co-cure with the alkenyl-containing polysiloxane and the polysiloxane having at least two silicon-bonded hydrogen atoms, and therefore may themselves contain alkenyl groups or silicon-bonded hydrogen groups. Such compounds may have the same structures as described above in connection with the alkenyl-containing polysiloxane and the polysiloxane having at least two silicon-bonded hydrogen atoms, but in addition have a viscosity of less than or equal to about 1000 centipoise (cps), preferably less than or equal to about 750 cps, more preferably less than or equal to about 600 cps, and most preferably less than or equal to about 500 cps. The reactive polysiloxane fluids preferably have a boiling point greater than the curing temperature of the addition cure reaction.

The polysiloxane fluid component is present in amount effective to allow the addition, incorporation, and wetting of higher quantities of conductive filler and/or to facilitate incorporation of the electrically conductive, flame retardant filler, for example to facilitate detangling and/or dispersion. Such quantities are readily determined by one of ordinary skill in the art. In general, the polysiloxane fluid component is added to the composition in an amount of about 5 to about 50 weight parts per 100 weight parts of the combined amount of the polysiloxane having at least two alkenyl groups per molecule, the polysiloxane having at least two silicon-bonded hydrogen atoms in a quantity effective to cure the composition, the catalyst, and the filler. The amount of the polysiloxane fluid component is preferably greater than or equal to about 5, more preferably greater than or equal to about 7.5, and even more preferably greater than or equal to about 10 weight parts. Also desired is a polysiloxane fluid component of less than or equal to about 50 weight parts, more preferably less than or equal to about 25 weight parts, and more preferably less than or equal to about 20 weight parts.

The silicone elastomers may further optionally comprise a curable silicon gel formulation. Silicone gels are lightly cross-linked fluids or under-cured elastomers. They are unique in that they range from very soft and tacky to moderately soft and only slightly sticky to the touch. Use of a gel formulation decreases the viscosity of the composition adversely, thereby allowing at least one of an increased filler loading, enhanced filler wetting, and enhanced filler distribution, thereby resulting in cured compositions having lower resistance and resistivity values and increased softness. Suitable gel formulations may be either two-part curable formulations or one-part formulations. The components of the two-part curable gel formulations is similar to that described above for LSR systems (i.e., an organopolysiloxane having at least two alkenyl groups per molecule and an organopolysiloxane having at least two silicon-bonded hydrogen atoms per molecule). The main difference lies in the fact that no filler is present, and that the molar ratio of the silicon bonded hydrogen groups (Si—H) groups to the alkenyl groups is usually less than one, and can be varied to create a “under-cross linked” polymer with the looseness and softness of a cured gel. Preferably, the ratio of silicone-bonded hydrogen atoms to alkenyl groups is less than or equal to about 1.0, preferably less than or equal to about 0.75, more preferably less than or equal to about 0.6, and most preferably less than or equal to about 0.1. An example of a suitable two-part silicone gel formulation is SYLGARD® 527 gel commercially available from the Dow Coming Corporation.

A preferred method for preparing the silicone elastomer from the compositions described above is mixing the different components to homogeneity and removal of air by degassing under vacuum. The composition is then poured onto a release liner and cured by holding the composition at room temperature (e.g., 25° C.), or by heating. When a non-reactive polysiloxane fluid is present, cure is at a temperature below the boiling point of the fluid so as to substantially prevent removal of the fluid during cure. Preferably, cure temperatures are at least about 20° C., preferably at least about 50° C., most preferably at least about 80° C. below the boiling point of the fluid component. When using reactive fluid, the cure temperature is such that the fluid cures before it can be driven off.

In a preferred continuous method for the preparation of the silicone elastomers, the appropriate amounts of each component is weighed into a mixing vessel, such as, for example, a Ross mixer, followed by mixing under vacuum until homogeneity is achieved. The mixture is then transferred onto a moving carrier. Another layer of carrier film is then pulled though on top of the mixture and the sandwiched mixture is then pulled through a coater, which determines the thickness of the final elastomer. The composition is then cured, followed by an optional post-cure.

The elastomeric silicones are particularly suitable for continuous manufacture in a roll form by casting, which allows the production of continuous rolls in sheet form at varying thicknesses, with better thickness tolerances. The present compositions may be used to make sheets having a cross-section less than 6.3 mm (0.250 inches), preferably in very thin cross sections such as about 0.005 to about 0.1 inches, which is useful, for example, in electronic applications.

Preferably, the electrically conductive silicone elastomers have mechanical properties similar to those of the same silicone elastomers without electrically conductive, flame retardant filler. Desirable properties include a Shore A Hardness of less than or equal to about 30, compression set of less than or equal to about 30, and an elongation of greater than or equal to about 20%.

Use of electrically conductive, flame retardant filler unexpectedly allows the manufacture of polymeric foams and elastomers that have excellent electrical conductivity and physical properties, particularly compression set and/or softness. These characteristics permit the polymeric foams and elastomers to be used as a variety of articles such as gasketing materials, particularly where electromagnetic and/or electrostatic dissipative properties are desired. The articles are suitable for use in a variety of commercial applications such as cell phones, personal digital assistants, computers, airplanes and other articles of commerce where hitherto only metal sheets and metallized meshes would be used. The following tests may be used to determine characteristics of the composites described herein.

Compression set is determined by measuring amount in percent by which a standard test piece of the elastomer or foam fails to return to its original thickness after being subjected to 50% compression for 22 hours at the specified temperature.

Modulus as reflected by compression force deflection (CFD) is determined on an Instron using 5×5 centimeter die-cut samples stacked to a minimum of 0.6 centimeters (0.250 inches), usually about 0.9 centimeters (0.375 inches), using two stacks per lot or run, and a 9090 kg (20,000 pound) cell mounted in the bottom of the Instron. CFD was measured by calculating the force in pounds per square inch (psi) required to compress the sample to 25% of the original thickness.

Tensile strength and elongation are measured using an Instron fitted with a 20 kilogram (50-pound) load cell and using 4.5-9.0 kilogram range depending on thickness and density. Tensile strength is calculated as the amount of force in kilogram per square centimeter (kg/cm²) at the break divided by the sample thickness and multiplied by two. Elongation is reported as percent extension.

Tear strength is measured using an Instron fitted with a 20 kilogram load cell and using a 0.9, 2.2, or 4.5 kilogram load range depending on sample thickness and density. Tear strength is calculated by dividing the force applied at tear by the thickness of the sample.

As is known, particular values for volume resistivity and electrostatic shielding will depend on the particular test methods and conditions. For example, it is known that volume resistivity and shielding effectiveness may vary with the pressure placed on the sample during the test. Useful electrical equipment and test fixtures to measure volume resistivity in the sample below are as follows. The fixture is a custom fabricated press with gold plated, 2.5 cm×2.5 cm (1 inch×1 inch) square, and electrical contacts. The fixture is equipped with a digital force gauge that allows the operator to control and make adjustments to the force that is applied to the surface of the sample. The Power supply is capable of supplying 0 to 2 amps to the sample surface. The Voltage drop and ohms across the sample are measured using a HP 34420A Nano Volt/Micro Ohmmeter. The electronic components of the fixture are allowed to warm up and, in the case of the HP 34420 A, the internal calibration checks are done. The samples are allowed to equilibrate, for a period of 24 hours, to the conditions of the test environment. Typical test environment is 50% Relative Humidity (% RH) with a room temp of 23° C. (70° F.). The sample to be tested is placed between the platens of the test fixture and a load is applied to the surface. The applied load is dependent on the type of sample to be tested, soft elastomers are tested using small loads while solids are tested using a load range from about 63,279 to about 210,930 kg/square meter (90 to 300 pounds per square inch). Once the load has been applied, the current is applied to the sample and the voltage drop through the sample thickness is measured. A typical test would include measurements at 4 different amp settings, 0.5, 1.0, 1.6, and 2.0 amps. For a conductive composite the resulting calculated volume resistivity for all four of the amp settings will be similar. The calculation for the volume resistivity is as follows:
Volume Resistivity(ohm-cm)=(E/I)*(A/T)
wherein E=voltage drop (V), I=current (amps), A=area (cm²), and T=thickness (cm).

Volume resistivity measurements are similarly made on elastomeric samples by cutting a rectangular sample, coating the ends with silver paint, permitting the paint to dry and using a voltmeter to make resistance measurements.

Use of electrically conductive, flame retardant filler enables the production of electrically conductive polymeric foams having a volume resistivity of about 10−3 ohm-cm to about 108 ohm-cm, and preferably less than or equal to about 106, less than or equal to about 104, or less than or equal to about 103, and more preferably less than or equal to about 102, less than or equal to about 10, and most preferably less than or equal to about 1 ohm-cm, as measured by the above-described method. Use of electrically conductive, flame retardent filler also allows the production of electrically conductive elastomers having a volume resistivity of about 10⁻³ ohm-cm to about 10³ ohm-cm, preferably less than or equal to about 10² ohm-cm, more preferably less than or equal to about 10, and most preferably less than or equal to about 1 ohm-cm.

Flammability testing is in accordance with Underwriter' Laboratories UL 94 Vertical Burning Test.

The following examples, which are meant to be exemplary, not limiting, illustrate compositions and methods of manufacturing of some of the various embodiments of the electromagnetically shielding and/or electrostatically dissipative and/or electrically conductive elastomers and polymeric foams described herein.

### EXAMPLE 1

An evaluation of nickel coated aluminum trihydroxide, (Al(OH)₃, “ATH”), for use in a silicone gel as a conductive and flame retardant additive was performed by coating ATH from Alcoa World Chemicals (C-33) using a standard nickel carbonyl gas process. Samples of the filler were evaluated in the following formulation comprising Dow Corning Gel3-4241(A) (15.4 parts by weight), Dow Corning Gel 3-4241(B) (15.4 parts by weight), and 19% Nickel Coated C-33 ATH (69.2 parts by weight). The components were mixed by hand, vacuum degassed, and coated between 0.005 inch polycarbonate films. Samples were drawn through a two-roll coater with a gap set of 0.018 inches. The sample was then cured for 10 minutes at 100° C., then 10 minutes at 125° C.

Volume resistivity testing gave the results shown in Table 1:

TABLE 1

| Sample | thick | thick | probe | area | | | | VR |
|---|---|---|---|---|---|---|---|---|
| No. | (in) | (cm) | (cm) | cm² | amps | mVolts | Volts | ohm-cm |
| 1 | 0.012 | 0.030 | 2.54 | 5.07 | 0.5 | 0.18 | 0.00018 | 0.0598 |
| 2 | 0.012 | 0.030 | 2.54 | 5.07 | 0.5 | 0.16 | 0.00016 | 0.0532 |
| 3 | 0.012 | 0.030 | 2.54 | 5.07 | 0.5 | 0.17 | 0.00017 | 0.0565 |
| 4 | 0.012 | 0.030 | 2.54 | 5.07 | 0.5 | 0.16 | 0.00016 | 0.0532 |
| 5 | 0.012 | 0.030 | 2.54 | 5.07 | 0.5 | 0.15 | 0.00015 | 0.0499 |

Average 0.0545

Flammability testing in accordance with UL-94 Vertical Flammability on samples 0.012 inches (30 cm) thick resulted in a rating of V-0.

### EXAMPLE 2

Samples of the above silicone elastomer (15 mil (381 micrometer) thick) were corona-treated on one side, then coated with a solvent-based acrylic pressure sensitive adhesive (Aeroset 1920, from Ashland Chemicals) comprising nickel coated aluminum trihydroxide particles (loading level of 50 weight % based on the dry weight of the total composition) to a thickness of about 1-2 mil; or a commercially available conductive pressure sensitive adhesive (available from 3M under the designation “9173”) to a thickness of about 2 mil, and a silicone PSA comprising nickel particles (loading level of 50 weight % based on the dry weight of the total composition)—it looks as if this data is missing. Volume resistivities were measured as described above. Results for the combined adhesive/elastomer are shown below in Table 2.

TABLE 2

| | | Acrylic PSA with Ni-coated |
|---|---|---|
| Test | 9173* | ATH |
| Volume resistivity (Ohms-cm) at | | |
| 25 psi | 1.72 | 0.24 |
| 50 psi | 0.86 | 0.14 |
| 100 psi | 0.70 | 0.10 |
| Flammability Rating (UL-94) | Not V-0** | V-0 |

*Comparative Example
**Adhesive burnt up to the clamp

### EXAMPLE 3

Silicone resins containing ATH coated with different amounts of nickel were made. The silicone resins were formulated using 45 wt. % of Dow Coming gel 3-4241 A/B (1/1 by weight) and 55 wt. % of Dow Coming Silastic S-2/S-2 Curing agent(10/1 by weight). Test samples were prepared as in Example 1. Results are shown in Table 3.

| | Sample No. | | | |
|---|---|---|---|---|
| | 6 | 7 | 8 | 9 |
| % Ni in Ni-ATH | 10 | 15 | 20 | 25 |
| % Ni-ATH Loading | 69 | 70 | 70 | 70 |
| Volume resistivity, ohm-cm | Not conductive | 0.04 | 0.03 | 0.07 |
| at 100 psi | | | | |
| UL-94 | V-0 | V-0 | V-0 | V-0 |

As can be seen from the above results, use of nickel-coated flame retardant particles can confer both excellent conductivity and flame retardancy. In addition, the data in Table 3 shows that adjusting the amount of nickel used to coat the particles can be used to adjust of the conductivity of the compositions.

While preferred embodiments have been shown and described, various modifications and substitutions may be made thereto without departing from the spirit and scope of the invention. Accordingly, it is to be understood that the present invention has been described by way of illustration and not limitations.

1. A particulate flame retardant material comprising flame retardant particles at least substantially coated with a conductive metal.

2. The material of claim 1, wherein the flame retardant particles comprise a flame retardant metal hydroxide, a flame retardant metal oxide, a flame retardant metal carbonate, a flame retardant metal borate, a flame retardant melamine, graphite, carbon black, a solid, flame retardant brominated compound, or a mixture comprising at least one of the foregoing flame retardants.

3. The material of claim 1, wherein the flame retardant particles comprise aluminum trihydoxide, magnesium hydroxide, antimony oxide, melamine cyanurate, melamine phosphate, or a mixture comprising at least one of the foregoing materials.

4. The material of claim 1, wherein the conductive metal comprises nickel, sliver, gold, copper aluminum, cobalt, iron, or a mixture or alloy comprising at least one of the foregoing metals.

5. A composition comprising
a polymeric composition; and
a filler composition, the filler composition comprising flame retardant particles at least substantially coated with a conductive metal.

6. The composition of claim 5 having a volume resistivity of about 10⁻³ ohm-cm to about 10⁸ ohm-cm, and meeting the UL-94 standard of V-1.

7. The composition of claim 5, wherein the polymeric composition is a pressure sensitive adhesive.

8. The composition of claim 5, wherein the polymeric composition is an elastomer.

9. The composition of claim 5, wherein the polymeric composition is a foam.

10. An article comprising a substrate coated with the composition of claim 6.

11. An article comprising the composition of claim 6.

12. An article comprising the composition of claim 7.

13. A composition comprising
a pressure sensitive adhesive composition; and
flame retardant particles at least substantially coated with a conductive metal, wherein the composition has a volume resistivity of about 10⁻³ ohm-cm to about 10⁸ ohm-cm.

14. The composition of claim 13, wherein the flame retardant particles are aluminum trihydrate and the metal is nickel.

15. A composition comprising
a polymeric foam; and
flame retardant particles at least substantially coated with a conductive metal, wherein the composition has a volume resistivity of about 10⁻³ ohm-cm to about 10⁸ ohm-cm.

16. The composition of claim 15, wherein the polymeric foam is a polyurethane foam, polyolefin foam, silicone foam, or a combination comprising at least one of the foregoing foams.

17. The composition of claim 15, wherein the composition has an electromagnetic shielding capacity of greater than or equal to about 50 dB.

18. A composition comprising
an elastomer; and
flame retardant particles substantially coated with a conductive metal, wherein the composition has a volume resistivity of about 10⁻³ ohm-cm to about 10³ ohm-cm.

19. The composition of claim 18, wherein the elastomer comprises a thermosetting resin and/or a thermoplastic resin, wherein the thermosetting resin is strene butadiene rubber, polyurethane or silicone or a combination comprising one of the foregoing thermosetting resins and wherein the thermoplastic resin is ethylene propylene diene monomer, ethylene propylene rubber, or elastomers derived from polyacrylics, polyurethanes, polyolefins, polyvinyl chlorides, or combinations comprising at least one of the foregoing thermoplastic resins.

20. The composition of claim 18, having a Shore A Durometer of less than 80 and an elongation to break of greater than 100%.

21. A method of manufacturing a polymeric foam, comprising:
frothing a liquid composition comprising a polyisocyanate component, an active hydrogen-containing component reactive with the polyisocyanate component, a surfactant, a catalyst, and flame retardant particles substantially coated with a conductive metal; and
curing the froth to produce a polyurethane foam having a density of about 1 to about 50 pounds per cubic foot, an elongation of greater than or equal to about 20% and a compression set of less than or equal to about 30.

22. A method of manufacturing a polymeric foam comprising:
extruding a mixture comprising an essentially linear single site initiated polyolefin, a blowing agent and an optional curing agent; and
blowing the mixture to produce a foam having a density of about 1 to about 20 pounds per cubic foot, an elongation of greater than or equal to about 100% and a compression set of less than or equal to about 70.

23. A method of manufacturing a polymeric foam comprising:
extruding a mixture comprising a polysiloxane polymer having hydride substituents, flame retardant particles substantially coated with a conductive metal, a blowing agent and a catalyst; and
blowing tie mixture to produce a silicone foam having a density of about 4 to about 30 pounds per cubic foot, an elongation of greater than or equal to about 50% and a compression set at 50% of less than or equal to about 30.

24. A method of manufacturing a polymeric foam comprising:
metering a composition comprising a polysiloxane polymer having hydride substituents, flame retardant particles substantially coated with a conductive metal, a blowing agent and a catalyst into a mold or a continuous coating line; and
foaming the composition in the mold or on the continuous coating line.

25. A method of manufacturing an elastomer comprising:
mixing a composition comprising an isocyanate, an active hydrogen-containing compound, flame retardant particles substantially coated with a conductive metal, and optionally a catalyst, where the mixed composition is substantially free of frothing; casting the mixed composition onto a substrate; and curing the mixed composition.

26. A method of manufacturing a polymeric elastomer comprising:
mixing a composition comprising an essentially linear single site initiated polyolefin, flame retardant particles substantially coated with a conductive metal, and an optional curing agent, wherein curing of the composition begins after mixing; and
optionally post-curing the composition using heat or electromagnetic radiation.

27. A method of manufacturing a polymeric elastomer comprising:
mixing a composition comprising a polysiloxane polymer having hydride substituents, flame retardant particles substantially coated with a conductive metal, and a catalyst;
contacting the composition onto a release liner; and
curing the composition at or above ambient temperature.

28. A method of manufacturing a polymeric elastomer comprising:
mixing a composition comprising a polysiloxane polymer having hydride substituents, flame retardant particles substantially coated with a conductive metal, and a catalyst;
contacting the composition onto a moving carrier to form a layer;
contacting a second carrier to the exposed face of the composition layer to form a sandwiched mixture;
pulling the sandwiched mixture through a coater;
curing the composition in the sandwiched mixture at or above ambient temperature; and
optionally post-curing the composition in the sandwiched mixture.
